(19) United States
(12) Patent Application Publication
(10) Pub. No.: US 2001/0042010 A1
(43) Pub. Date: Nov. 15, 2001

(54) Electronic offer method and system

(76) Inventor: David A. Hassell, Clifton, NJ (US)

Correspondence Address: Morgan & Finnegan L.L.P., 345 Park Avenue, New York, NY, 10154, US

(21) Appl. No.: 09/726,080

(22) Filed: Nov. 29, 2000

Related U.S. Application Data
(60) Provisional application No. 60/168,977, filed on Dec. 3, 1999.

(51) Int. Cl. G06F 17/60

(52) U.S. Cl. 705/14

(57) ABSTRACT

A method involves receiving a clippable coupon message representing a selection by a user of an item, assigning an entry to a folio for the user, and tracking for a coupon usage from the folio. A computer program stored on computer readable medium is also described. The program has a module to receive a clippable coupon message and a module to track clippable coupon usage.

### CROSS-REFERENCE TO RELATED APPLICATIONS

This application claims priority under 35 USC 1 19(e)(1) of provisional patent application Ser. No. 60/168,977 filed Dec. 3, 1999.

### BACKGROUND

Online marketers face limited choices when investing in advertising and promotional campaigns. Currently two prevailing models exist for “methods of delivery” of advertising online, these include a “Push-Impulse” process exemplified by media placement or “banner” advertising, and a “Pull-Deferral” process exemplified by fixed distribution advertising or traditional coupons. The former is well suited for generating online brand recognition, and the later for causing transactions or increasing sales. Both of the above processes/models have a number of strengths.

Coupons have benefits in that they have long been recognized as a means of advertising and increasing sales. The popular press has noted that shoppers are predisposed to using coupons to save money. In addition to printed coupons, coupons are also available online, for example, from www.e-centives.com or www.coolsavings.com, and various forms of online coupons are described in U.S. Pat. Nos. 5,907,830, 5,710,886, 5,909,023, 5,845,259, 5,855,007, 5,903,874, 5,806,044, 5,905,246, 5,915,243 and 5,970,469.

Banner advertising can be considered “disruptive” because it requires a change in the process a web user is involved in (i.e. hyper-linking or jumping to another site or system) to realize its fill value. Current on-line coupon schemes suffer from the disadvantages of “pull based” advertising because users must be attracted to an intermediary's site or system in order to view, collect, print, capture, organize or redeem online coupons. As a result, consumer reach is constrained by the coupon site's ability to attract and retain users. Thus, there is a need for Web-based promotional advertising with the attraction of coupons with the reach of direct response ad media, but without the disruptive nature of direct response banner advertising.

### SUMMARY OF THE INVENTION

By recognizing that many of the weaknesses of each of the processes/models can be overcome, an advertising vehicle has been devised which involves presentation of offers or coupons throughout the Internet, via web browser, PDA, wireless, POS, cellular, interactive television, or other devices and can be dynamically optimized to increase sales while still providing the advantages of branding. As a consequence, the benefits of promotional incentives as well as the customer reach and branding strengths of run-of-network and targeted banner advertising can be obtained. Using this advertising vehicle marketers can manipulate campaigns both while they are being deployed and after deployment. Additionally, the advertising vehicle allows marketers to integrate multiple media campaigns, an ability often considered important for online-offline advertising campaigns, through a Portable Clippable Digital Object (PCDO) model.

In general, a first aspect of the invention involves a method involving receiving a clippable coupon message representing a selection by a user of an item, assigning an entry to a folio for the user, and tracking for a coupon usage from the folio.

In general, a second aspect of the invention involves a computer program stored on computer readable medium. The program has a module to receive a clippable coupon message and a module to track clippable coupon usage.

Still other aspects involve numerous additional features and provide further advantages beyond those set forth herein, the enumerated advantages and features described herein being a few of the many advantages and features available from representative embodiments. These enumerated advantages and/or features are presented only to assist in understanding the invention. It should be understood that they are not to be considered limitations on the invention as defined by the claims, or limitations on equivalents to the claims. For instance, some of these advantages are mutually contradictory, in that they cannot be simultaneously present in a single embodiment. Similarly, some advantages are applicable to one aspect of the invention, and inapplicable to others. Thus, the specifically referred to features and advantages should not be considered dispositive in determining equivalence. Additional features and advantages of the invention will become apparent in the following description, from the drawings, and from the claims.

### BRIEF DESCRIPTION OF THE DRAWINGS

FIG. 1 is a typical arrangement employing the principles of the invention;

FIG. 2A is an example web page containing a coupon as described herein;

FIG. 2B is the web page FIG. 2A after the coupon has been clipped;

FIG. 3 is an example new user registration page;

FIG. 4 is an example folio;

FIG. 5 is a flow diagram in accordance with the principles of the invention;

FIG. 6A is an example coupon before it has been clipped;

FIGS. 6B-6D are examples of the coupon of FIG. 6A after it has been clipped; and

FIG. 7 is an additional example folio.

### DETAILED DESCRIPTION

The problem and shortcomings in the art are addressed by providing a consumer friendly click-through metric that does not require the person to actually leave the site they are currently browsing.

In overview, one embodiment has as an advantage that it allows customers to select an advertisement or coupon on a website without leaving the site. As a result, advertisers' sites become more “sticky” and users are more prone to look at and select the advertisement making them more likely to purchase the item.

Another embodiment allows advertisers to more easily track the return on their advertising dollar investment by allowing a specific purchase to be traceable to a specific website visit. In this way advertisers will be able to quickly and easily realize their return on investment.

A person surfing the web sees a displayed coupon, for example, as an image, link or icon possibly displayed much as a banner advertisement would be displayed. As used herein, the terms coupon, image and icon are used interchangeably. When the person clicks on the coupon to “clip” it, they are not brought to another page as with a banner ad. Instead, a message is sent to a server which, if the coupon is valid and the person has an account, will cause a placement of the coupon into the person's account. Information related to the coupon's value, duration, origination, history, etc. is kept on the same server or a separate server configured for that administrative purpose and which is wholly inaccessible to users.

If the coupon is valid but the person does not have an account, the person is given the option of creating an account. Irrespective of whether the person has an account, if the coupon is not valid, an error is generated.

When the person is registered, they can then log into their account and, in one arrangement, view any unused clipped coupons and redeem any valid clipped coupon at the appropriate site. In other arrangements, the person can also send, receive or transfer coupons among accounts, for example, for classification or trading purposes.

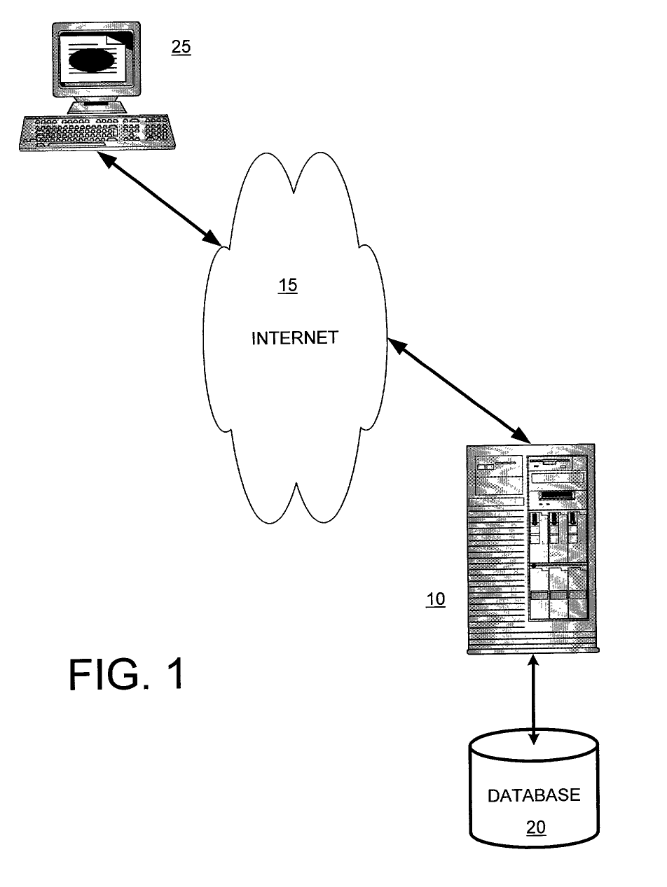

FIG. 1 shows a typical arrangement for the entities and components involved in a transaction in accordance with the principles of the invention. The system is made up of one or more servers 10 connected to the Internet 15 and a database 20. The servers 10 are accessible by one or more users via the user's personal computer 25, a kiosk, Internet accessible cell phone, etc. capable of connecting to the Internet and running client side routines, for example, modules, plug-ins or applets. For simplicity, only one server 10 is shown however, it is well known that the server functionality described herein can be distributed among multiple servers, for example, with one or more servers interfacing to the Internet 15, another server operating the database and yet another server connected to one or more of the interface servers for, for example, load balancing, website administration, security or other purposes.

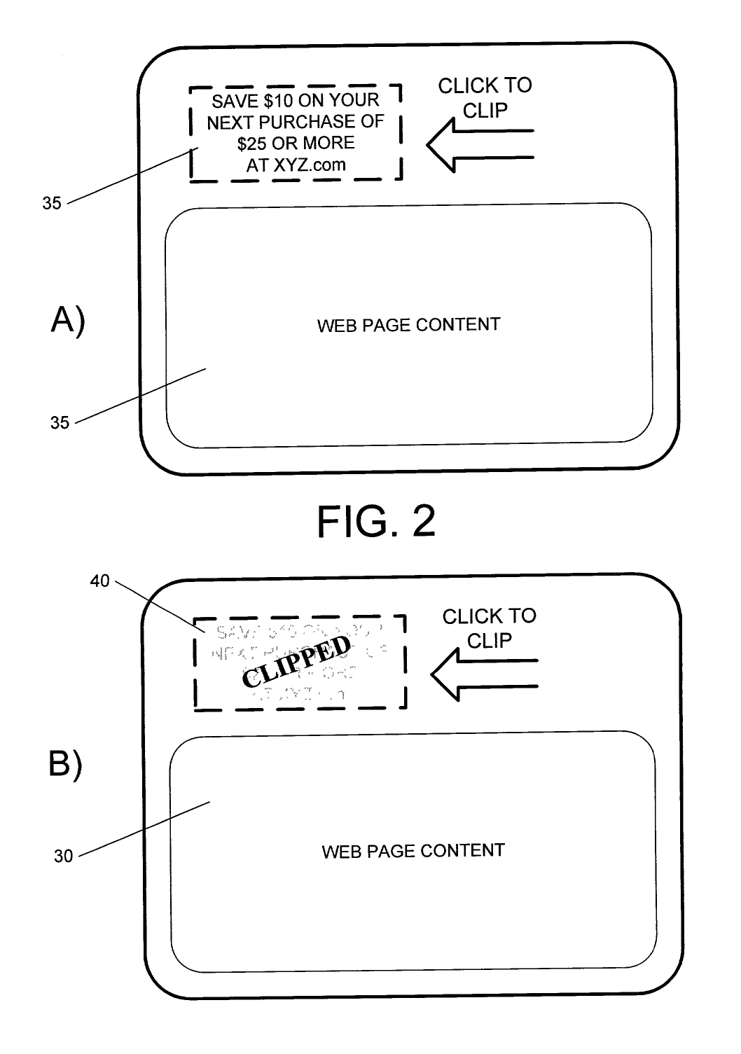

FIG. 2A shows a typical web page as would be displayed on a user's web browser, such as Internet Explorer, Netscape Navigator, etc. or their analog if a hand held device such as a cell phone is used. In addition to its normal content 30, the web page includes one or more selectable items, images 35 or links which serve as the on-line “coupon”. The coupon 35 includes embedded information regarding its validity and which directly or indirectly identifies its value. Optionally, the information may also identify, directly or indirectly, the displaying website, a redemption website, a timing indication such as, for example, the day date and/or time the coupon was clicked, an expiration indication, any transfers among folios or users, or any such other information which would normally be associated with conventional coupons.

A visitor to the website clicks on the image to effectuate a selection or “clipping” of the coupon. As shown in FIG. 2B, once selected, the image of the coupon is changed 40 to reflect that it has been clipped. In general, there are two types of persons who can select one of the coupons, a non-registered user and a registered user. A non-registered user is someone who does not have an established coupon “folio”. Each registered user has at least one registered coupon folio.

Registration

Registration allows a non-registered user to become a registered user. The registration process proceeds as follows. A person connects to the coupon administration server, either directly, by going to a registration website, for example, using a universal resource locator (URL), clicking a link to the registration site or indirectly by clipping a coupon on a host website.

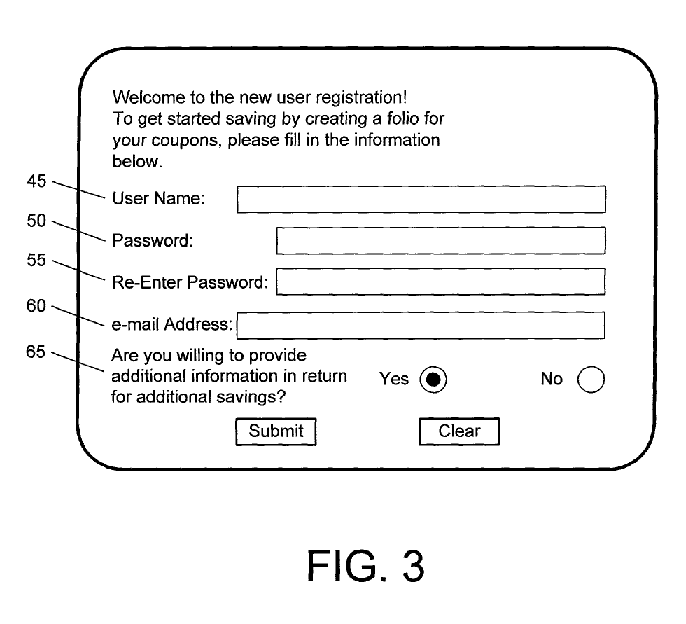

A registration webpage is displayed for example, as shown in FIG. 3, which allows the user to, for example, select a username 45 and a password 50 which will enable them to log into the system. In some embodiments, the user may optionally be prompted for a second entering of a password 55 and/or an e-mail address 60. Alternatively, the system can assign a username, password or both. The user may optionally also be prompted for, or given the option to provide, additional information 65, for example, a mailing address, credit card, phone number, or hint to allow them to identify themselves to the system to obtain a forgotten username or password. Advantageously, and as will be described in greater detail below, by tracking the supplied user information and the coupon over its life valuable marketing information may be obtained.

Once registered, the system creates an account and a folio for the user. A folio is a visible manifestation of an existing account and provides a way of organizing clipped coupons on line. In its simplest form, a folio is a viewable list of all unused coupons. In more complex forms, it may be a set of images corresponding to or representing the clipped coupons. In still other forms, a folio may resemble an on-line version of a coupon organizer which allows organizing the coupons into folders by, for example, category, expiration, value, redemption location, etc.

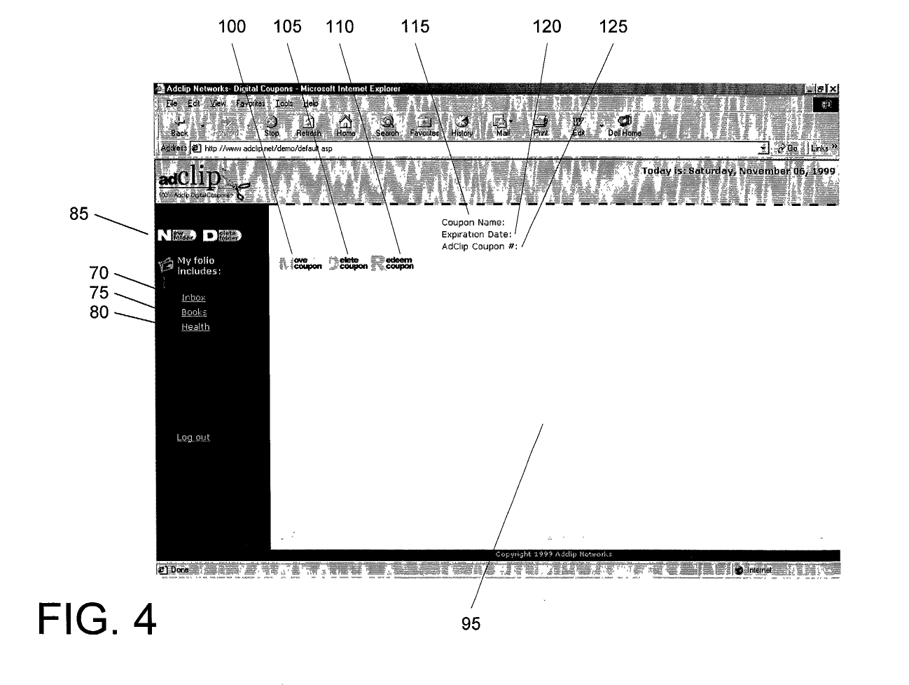

FIG. 4 is one example folio. As shown, the folio includes three folders—Inbox 70, Books 75 and Health 80. Within the inbox category are the coupons which have been clipped, but not yet classified. The books 75 and health 80 categories may be user created categories that allow the user to organize their coupons. The folio also includes options to add a folder 85 and delete a folder 90. When a user selects a particular folder in the folio, for example, the Inbox folder 70, the coupons categorized to that folder will be visible in a display area 95. Depending upon the implementation, clipped coupons may be displayed as images, descriptions, list items or other representative entries. Additionally, in some embodiments, users are given the option to move a coupon 100, either to a different folder or a different folio. When this option is selected, the user can specify the coupon destination. When a destination is selected, the coupon instance is either transferred to the indicated folder or, when a different user ID is specified, deleted from the folio.

The user is also given the option of deleting a coupon 105 for example, if the user has no interest in ever using the coupon. As will be described in greater detail below, in different implementations, deleting a coupon may have different effects.

The user can also redeem a coupon from their folio. This may be done in several ways, depending upon the implementation. For example, the user may select a coupon in the folio and then select a “Redeem Coupon” option 110. In addition, or alternatively, the user can invoke a redemption directly, for example, by double clicking on the coupon. When a coupon is selected for redemption, the user is automatically linked to the redemption website and a secure connection is established between the redemption website and the coupon server system so that the necessary information related to the coupon can be passed to the redemption site. Depending upon the implementation, the mere access of the redemption site may cause the coupon to be used up and hence, eliminated from the folio. In other implementations, once a specified action occurs on a website, for example selecting an item for purchase or accessing a shopping cart page may cause the coupon to be used up, even if no item is purchased. In some embodiments, the coupon is not deleted until a message is received from the redemption site, and of course, if an item is purchased using the coupon it will be deleted.

In some embodiments, it may also be useful to display further information about the coupon when it is selected for example, a coupon name 115, its expiration (if any) 120, and/or a coupon number 125, for example if the coupon is part of a limited issue series.

In addition to creating an account and folio for the user, during registration, the system may store information on the user's computer, in the form of one or more cookies, using the person's web browser. This information is used, when a coupon is clipped, to allow the system to locate the account into which the coupon should be registered.

Process Flow

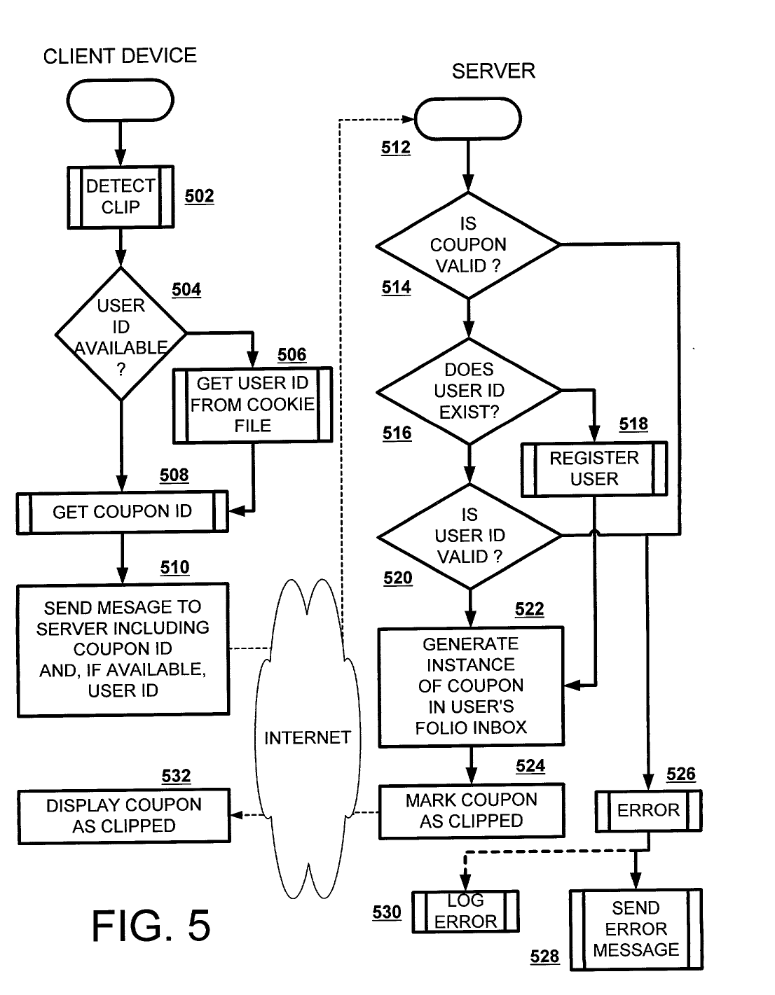

With reference to FIG. 5 which is an illustrative example of the process flow in a system employing the principles of the invention, when the user clips (i.e., selects) the item, icon, link or coupon (step 502), it initiates execution of a module, plug-in or applet on the client device which will cause an encrypted message to be sent to the coupon server. Advantageously, the arrangement employs a minimal client side routine (i.e., a module, plug-in or applet) to facilitate fast client side interactions and minimize any burden on the coupon hosting site, placing the bulk of the operational burdens on the backend server. Two representative examples of minimal client-side routines are shown in Table 1 and Table 2 where:

<coupon_name>=the dynamic, encoded name used for any given coupon;

<coupon_server>=the name of the coupon server on the Internet;

<path>=the directory path to where <script>or <coupon_name>is located;

<script>=the server-side application that processes a clip;

<width>& <height>=parameters that specify the image size of the coupon;

<params>=an encoded set of additional parameters passed to the <script>and written in the form:

param1=value1&param2=value2& . . . &paramx=valuex

When the image is clicked, the script tells the browser to replace the initial image with another image The path of the other image is actually a script that processes the clip and returns an image, indicating the coupon was clipped, to the browser if the clip is successful.

TABLE 1
<a href=″″
onClick=“document.<coupon_name>.src=′http://<coupon_server>/
<path>/<script>?
<params>′; return false;“><img src=′http://<server>/<path>/
<coupon_name>”
NAME=“<coupon_name>”alt=“<coupon_name>”
.width=<width>height=<height>
border=0></a>

TABLE 2
<SCRIPT SRC=“http://<server>/<path>/xxx.js”></SCRIPT>
<a href=″″onClick=clip(); return false;“><img
src=”http://<server>/<path>/<coupon_name>”
NAME=“<coupon_name>”
alt=“<coupon_name>”.width=<width>height=<height>
border=0></a>

Where the clip( ) in Table 2 is a function residing in the xxx.js file on the <server>that will perform verification of the coupon and user.

It will be understood that other routines implemented as modules, plug-ins or applets providing similar or analogous functionality may be used. Additionally, depending upon the implementation, it may be desirable or necessary for the client or hosting site to assume some of the burden assumed by or attributed herein to the backend server.

The routine determines if a user ID is available (step 504), for example in the case of a home computer, by examining for a stored cookie file on the client device and, if it exists, checking its contents. If the user ID is available, it is read (step 506). If the user ID is unavailable, most likely because the user is unregistered or registered from a different device, that information can not be provided. Depending upon the embodiment, the message may be populated with information indicating the absence of a user ID or may simply be left blank. In either event, the embedded coupon ID is obtained (step 508) and populated into the message. The message is then sent (step 510), over the Internet, to the coupon server system.

The system receives the message (step 512) and uses the coupon information to determine if the coupon is valid (step 514) and checks for a user ID (step 516) to determine if an account exists for that user.

If the user's identity is not known but the coupon authenticity is verified, this indicates a new user and the registration process is invoked (step 518). If the clipping of a coupon triggers the registration process, one embodiment of the system stores the coupon information and a temporary identifier for later crediting to the user's account. In this embodiment, the system sends a message to the user asking them to register to create a new account. Upon receipt of this information, which may include a request for an e-mail address, the system sends an appropriate email to that e-mail address telling the user to login to their account on the system's site. When the user does, the system locates the non-allocated coupon and inserts the coupon into the folio for the user's account.

If, either the user ID or the coupon is detected to not be authentic or, for some reason invalid (step 514, 520), an error is generated (step 526) and an error message is sent (step 528). Optionally, a security log entry may also be kept and, in the event an invalid coupon is identified, a notation in the security log identifying the coupon and/or the user will be made (step 530).

If the user's account and coupon's identities are known and valid then, an instance of the coupon is generated and credited to the customer's account (step 522). If appropriate, a folio for the user is updated with the coupon's information or appearance, for example by placing the coupon information or image in the user's folio inbox.

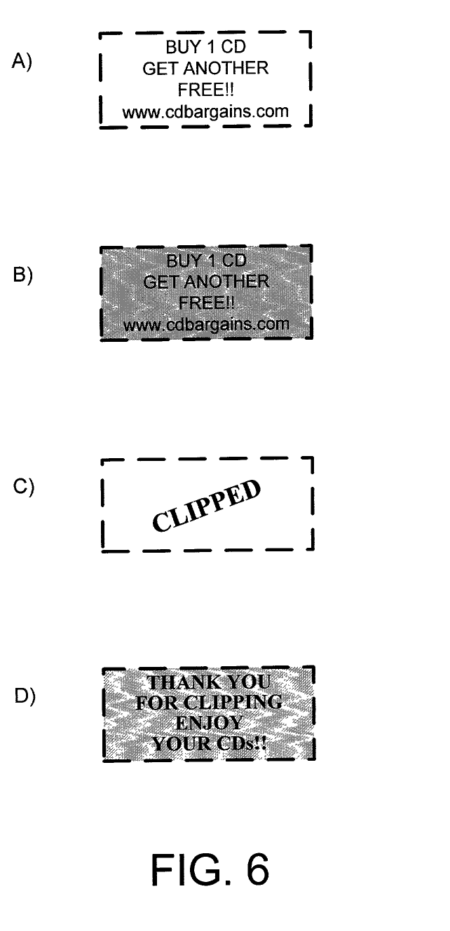

Once the instance has been added to the folio, the coupon is marked as clipped in the server (step 524) and the viewed page is updated to reflect that the coupon was clipped (step 532). Depending upon the implementation, this may result in the coupon image disappearing from the page, or may result in a change in the look of the image. For example, FIG. 6A is an example coupon as it would be displayed. FIGS. 6B, 6C, 6D are representative examples of images which would be displayed when the coupon of FIG. 6A is clipped.

In some alternative embodiments, for example where the client device is a personal computer, the user can right click on the coupon. By doing so, a message is automatically sent to the system which invokes the registration process even if the user is already registered. In this manner, a user can create multiple accounts or folios as they desire.

Coupons (Portable Clippable Digital Offers (PCDO))

Although appearing to be resident on a host site, in a folio or being transferable, a coupon actually resides in the server system in that information necessary for use, transfer, duplication, forgery or reuse prevention, authentication, and transfer history are user inaccessible. This has several advantages. Since a user never has access to information which would allow duplication or forgery of a coupon, the risk of duplication or forgery is low. Each coupon is also unique in that it is actually “created” when it is clipped and any aspect of the coupon, from the value, to the look, to the expiration, etc. is dynamic in that it can change when viewed, clipped, or thereafter. Thus, an advertiser can specify the particular values for coupons targeted to particular users and even change the value for coupons already clipped or coupons not yet clipped.

Additionally, since the system never loses track of any given coupon during its life, coupon information may be changed by the system during its life span and detailed information about the user may be obtained, for example, purchasing habits, likes and dislikes, clipping to usage ratios, etc. Moreover, from the advertiser perspective, important market research information may be obtained. For example, a given advertiser may offer coupons for the same items in differing amounts to determine the discount amount which produces the greatest amount of traffic or sales. Similarly, this information allows an advertiser to offer consumers specifically targeted discounts which are more likely to result in increased sales. In other embodiments, advertisers can implement a micro pricing model whereby the value of a coupon can vary based upon factors such as the hosting website, time of day, duration to expiration, the coupon's transfer history, the popularity, an optimal pricing analysis or the redemption site.

In short, every event in the “life” of the coupon is tracked, can cause a modification, can be analyzed for a given individual user, demographically across multiple users and/or according to coupon or advertiser specific parameters. In this manner, the system can provide suppliers with direct, unobtrusive access to consumers matching specific collected demographics. Additionally, the system can also provide incentives for coupon use, for example by increasing or decreasing a clipped coupon's value based upon a specified criteria. In this manner, users will have an incentive to use the coupons they clip. For example, as a coupon approaches expiration, its value may “incubate” or be increased so as to induce the clipper to redeem it, much in the way a “double-coupons” promotion increases sales. Similarly, a coupon's value can “atrophy” or decrease over time, thereby inducing early use or transfer to someone who would use it. Alternatively, a coupon's value can change based upon a user profile, for example, as a reward for a purchase.

Other coupon variants can require collection of multiple coupons before any can be used. For example, an advertiser can specify that three items each be clipped from three different locations before a specified coupon will exist in the folio. In that embodiment, each item clip is tracked as if it is a coupon and moved to the folio, but when the third item is clipped, the three items are replaced in the folio with a redeemable coupon. In this manner, clips can work like a form of frequent visitor or frequent buyer card. In another variant, individual coupons may be individually redeemable, but the clipping of two or more different coupons can result in replacement with a new coupon of higher value than either coupon individually. For example, a coupon may specify 10% off on item A. Another coupon may specify 10% off on coupon B. If a person clips both coupons however, a coupon providing 15% off item A or item B may be placed in the folio.

Warehouse

All information on every individual user's clip history, clip requests, clip use and clip trades is tracked and compiled in a database called a “warehouse.” The warehouse is constructed to be searchable so that the data may be analyzed in accordance with, for example, advertiser, market research firm or analyst needs. In this manner, a detailed user profile or history may be created for each registered user. It should now be apparent that, this combination of advertiser, coupon and user histories, in the warehouse can be an invaluable marketing or advertising resource. The warehouse offers a way to analyze consumer demographics, purchasing trends, traits and metrics to allow advertisers to implement highly cost-effective marketing campaigns. A company can unobtrusively develop consumer profiles based on user provided data, clipping trends, trading trends, requests for coupons and coupon redemptions. This data can significantly enhance the ability of advertisers to effectively target their market audience, insure consumers will be provided with the most applicable coupons, and predict consumer trends.

An additional benefit to the warehouse is that advertisers can be charged based upon any one or more of three metrics: per coupon display, per clip and per redemption. Moreover, in some embodiments, advertisers may be able to select the charge metric to be used for a given class of customers, coupon run or other criteria. In this way cost optimization or greater cost efficiency can achieved.

Additional Embodiments

Advantageously, the coupons described herein may optionally be extended beyond website placement, for example, to off-line media such as print ads, television, radio and/or billboards. With this extension, a code or identifier accompanies the ad. To “clip” the coupon, the user would visit a designated website and enter the code or identifier. The entering of the code or identifier would then be treated by the system like a message received when an on-line coupon was clipped. The user ID would be missing, so the user would be prompted to log in if they were a registered user. In all other respects, the system would operate in accordance with the principles discussed herein, for example, using one of the representative embodiments described herein.

In similar fashion, the system can “offload” coupons, for example, to a smart card, for redemption. In this embodiment, the information which would be transmitted by message from the client system is loaded by the user onto a card or other transportable device and deleted from the folio. To redeem the coupon, the card or device contents are uploaded onto another computer or used directly, for example using a smart card reader at the point of sale.

In still other embodiments, when a registered user logs on, the system can optionally include a coupon area where the customer can view targeted coupons, selected based upon an analysis of the information in the warehouse. The user can then additionally clip these user-specific coupons to their folio. This approach is advantageous to consumers because they can be given the opportunity to select from the best of the best coupons, limited offers, etc. This approach also benefits advertisers because the costs, annoyance and negative perception associated with conventional junk mail advertising is reduced or eliminated.

In other embodiments, the system is constructed so that a user who has clipped a coupon, but will not use it, can either return it to a general pool for allocation to another user or can offer it to other users in return for current or future coupons. Conversely, if users are aware of limited coupons that were available but have since all been clipped, they can post a desire to obtain that coupon. If someone responds, the system can effectuate the transfer to the requestor's folio.

In still other embodiments, users can request coupons from merchants or advertisers, even if no such coupons have ever been offered through the system. In this manner, the system can compile data which might induce the requested merchant to offer coupons through the system.

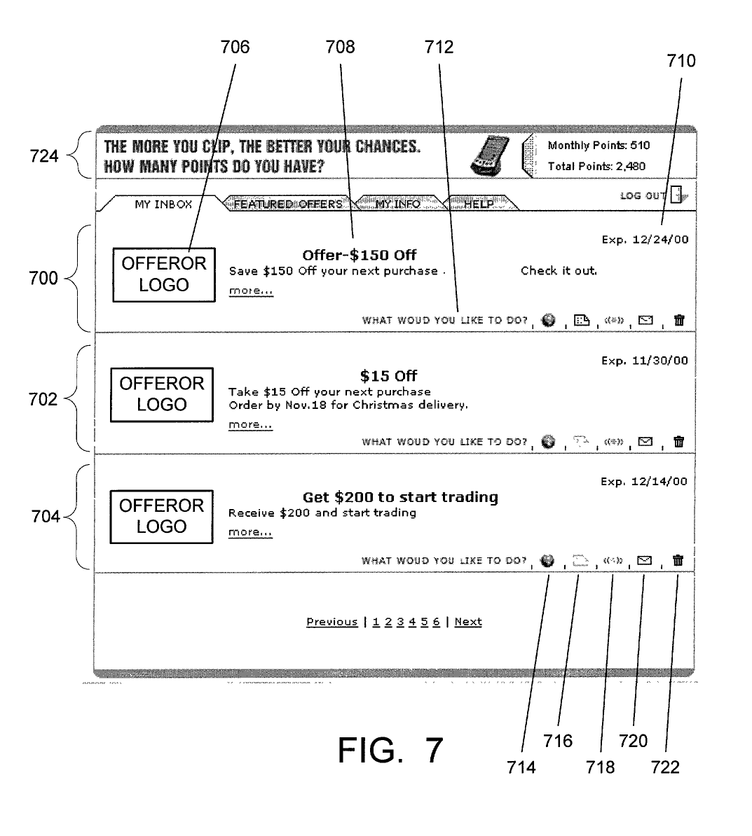

In still other embodiments, an alternative folio such as shown, by way of example, in FIG. 7 can be used. In the example folio of FIG. 7, three clipped coupons 700, 702, 704 are shown. Each includes an optional space 706 for display of an offeror related logo, image or icon. Advantageously, the space 706 can be rendered “hot” such that if the space is clicked the offeror's or redemption site is automatically linked to and the coupon will be set up for immediate redemption. Additionally, there is an area for displaying coupon details 708 and an area for displaying coupon expiration 710.

In still other embodiments, the coupon can include an optional control bar 712, illustratively labeled in FIG. 7 with “What would you like to do?” The control bar can include any or all of a number of “control points” that are implemented as attributes associated with a coupon and stored in the system. As shown, by way of example, each coupon has five attributes 714, 716, 718, 720, 722. Each attribute, when clicked, causes a specified action to be performed. For example, the first attribute 714, illustratively a globe, takes the user to a specified site (typically the sponsor's website) to redeem the coupon. The second attribute 716, illustratively a printed page, causes the coupon to be printed. The third attribute 718, illustratively a “wireless” symbol, provides directions as to how to redeem the coupon using a wireless device such as a cell phone or a hand-held computer having wireless web access (typically using the WAP protocol). The fourth attribute 720, illustratively a letter, causes the coupon to be e-mailed to an address specified by the user or to transfer the coupon to another user's folio. The fifth attribute 722, illustratively a trash can, discards the coupon from the folio.

Advantageously, since the control bar attributes are coupon specific they can be disabled on an individual basis to comport with the coupon offer. For example, the second displayed copon provides for $15 off the next on-line purchase. Accordingly, the “printed page” attribute associated with that coupon is disabled (greyed out) since it can only be redeemed on line (i.e. it can not be redeemed using a printed coupon). Similarly, in the third coupon, which is for an on line stock brokerage, both the “printed page” and “wireless” attributes are disabled because the coupon must be redeemed on line and the brokerage does not support access from wireless devices.

Additionally, in other embodiments, one or more area(s) 724 can be set aside so that if, for example, a loyalty program is available, information about the current state of the loyalty account and/or special offers, etc. can be displayed.

It should be apparent that although various processes and implementations have been discussed, in many cases, some of those processes or their component parts can happen in different orders or concurrent with other steps. Similarly, various implementation differences can readily be employed, such as distributing databases or using multiple loosely or tightly coupled processors. Thus, while a number of embodiments have been shown and described, it should be understood that the above description is only representative of illustrative embodiments. For the convenience of the reader, the above description has focused on a representative sample of all possible embodiments, a sample that teaches the principles of the invention, further embodiments may also result from a different combination of decided portions of different embodiments. The description has not attempted to exhaustively enumerate all possible variations. That alternate embodiments may not have been presented for a specific portion of the invention, may result from a different combination of described portions of different embodiments, or that further undescribed alternate embodiments may be available for a portion, is not to be considered a disclaimer of those alternate embodiments. It will be appreciated that many of those undescribed embodiments are literally within the scope of the invention and others are equivalent.

What is claimed is:

1. A method comprising:
receiving a clippable coupon message representing a selection by a user of an item;
assigning an entry to a folio for the user; and
tracking for a coupon usage from the folio.

2. The method of claim 1, further comprising developing consumer profiles based on clippable coupon usage.

3. The method of claim 2, wherein the consumer profiles are based on user provided data.

4. The method of claim 2, wherein the consumer profiles are based on clipping trends.

5. The method of claim 2, wherein the consumer profiles are based on trading trends.

6. The method of claim 2, wherein the consumer profiles are based on requests for coupons.

7. The method of claim 2, wherein the consumer profiles are based on redemptions of coupons.

8. The method of claim 1, further comprising analyzing clippable coupon usage.

9. The method of claim 1, wherein the clippable coupon message is obtained by Wireless Application Protocol.

10. The method of claim 1, wherein the clippable coupon message is obtained by HyperText Transfer Protocol.

11. A computer program stored on computer readable medium, the program comprising:
a module to receive a clippable coupon message; and
a module to track clippable coupon usage.

12. The method of claim 11, further comprising:
a module to develop consumer profiles based on clippable coupon usage.

13. The method of claim 12, wherein the consumer profiles are based on user provided data.

14. The method of claim 12, wherein the consumer profiles are based on clipping trends.

15. The method of claim 12, wherein the consumer profiles are based on trading trends.

16. The method of claim 12, wherein the consumer profiles are based on requests for coupons.

17. The method of claim 12, wherein the consumer profiles are based on redemptions.

18. The method of claim 11, further comprising:
a module to analyze clippable coupon usage.

19. The method of claim 11, wherein the clippable coupon message is obtained by Wireless Application Protocol.

20. The method of claim 11, wherein the clippable coupon message is obtained by HyperText Transfer Protocol.

21. A method comprising:
obtaining a clippable coupon message;
determining clippable coupon validity;
determining if an account exists for a user, and if no account exists, registering the user,
determining validity of a user identity; and
storing coupon data related to the clippable coupon message.

22. The method of claim 21, wherein the coupon data includes coupon usage information.

23. The method of claim 22, wherein the coupon data includes a transfer history.

24. The method of claim 21, wherein the clippable coupon message is obtained by Wireless Application Protocol.

25. The method of claim 21, wherein the clippable coupon message is obtained by HyperText Transfer Protocol.

26. A computer program stored on computer readable medium, the program comprising:
a module to receive a clippable coupon message;
a module to determine clippable coupon validity;
a module to establish if an account exists for a user, and if no account exists, registering the user;
a module to determine user identity validity; and
a module to store coupon data based upon the clippable coupon message.

27. The medium of claim 26, wherein the coupon data includes coupon usage information.

28. The medium of claim 27, wherein the coupon data includes a transfer history.

29. The medium of claim 26, wherein the clippable coupon message is received by Wireless Application Protocol.

30. The medium of claim 26, wherein the clippable coupon message is received by HyperText Transfer Protocol.

31. A method comprising:
tracking clippable coupon usage; and
charging advertisers based on usage metrics derived from the tracking.

32. The method of claim 31, wherein the usage metrics are based upon a per clippable coupon display.

33. The method of claim 31, wherein the usage metrics are on a per clip basis.

34. The method of claim 31, wherein the usage metrics are based upon redemptions.

35. A computer program stored on computer readable medium, the program comprising:
a module to store information indicative of clippable coupon usage; and
a module to debit advertisers based upon coupon usage metrics.

36. The method of claim 35, wherein the coupon usage metrics are derived from a number of clippable coupon displays.

37. The method of claim 35, wherein the coupon usage metrics are per clip based.

38. The method of claim 35, wherein the coupon usage metrics are per redemption based.

39. A method comprising:
identifying unused clippable coupons for parameter change; and
specifying a new clippable coupon parameter for an identified unused clippable coupon.

40. The method of claim 39, wherein the new clippable coupon parameter changes a value for the clippable coupon.

41. The method of claim 39, wherein the new clippable coupon parameter changes a time parameter for the clippable coupon.

42. A program stored on computer readable medium, the program comprising:
a module to identify unused clippable coupons for a parametric change;
a module to determine the parametric change for a clippable coupon:
a module to update the clippable coupon with the parametric change.

43. The method of claim 42, wherein the parametric change modifies a monetary value for the clippable coupon.

44. The method of claim 42, wherein the parametric change modifies a time parameter for the clippable coupon.

45. A method comprising:
displaying a clippable coupon;
detecting a coupon clip;
obtaining a user identifier if it is available;
obtaining a clippable coupon identifier;
sending a message including the clippable coupon identifier, and if available, the user identifier; and
updating the displaying to reflect the clippable coupon as clipped.

46. The method of claim 45, further comprising displaying an error message based upon a determining that a user identity is invalid.

47. The method of claim 45, further comprising displaying an error message based upon a determining that a coupon is invalid.

48. The method of claim 45, further comprising:
storing the user identifier in a cookie file on the client device.

49. The method of claim 45, further comprising:
obtaining the user identifier from a cookie file on the client device.

50. The method of claim 45, further comprising:
sending the clippable coupon identifier using a Wireless Application Protocol.

51. The method of claim 45, further comprising:
sending the clippable coupon identifier using a HyperText Transfer Protocol.

52. A computer program stored on computer readable medium, the program comprising:
a module to display a clippable coupon;
a module to detect a coupon clip;
a module to receive a user identifier if it is available;
a module to receive a clippable coupon identifier;
a module to send a message including the clippable coupon identifier, and if available, the user identifier; and
a module to alter the display to indicate the clippable coupon as being clipped.

53. The method of claim 52, further comprising a module to display an error message that a user identity is invalid.

54. The method of claim 52, further comprising a module to display an error message that a coupon is invalid.

55. The method of claim 52, further comprising a module to store the user identifier in a cookie file on a client device.

56. The method of claim 52, further comprising a module to obtain the user identifier from a cookie file on a client device

57. The method of claim 52, further comprising a module to identify a coupon for a parameter change.

58. The method of claim 52, further comprising a module to identify a coupon for an expiration related change.

59. A computer program stored on computer readable medium, the program comprising:
a module to receive a the message including the clippable coupon identifier, and if available, the user identifier;
a module to determine validity of clippable coupons;
a module to register a user if the user is a new user;
a module to generate an instance of a clippable coupon in an account associated with the user when the user clips the clippable coupon;
a module to mark the clippable coupon as clipped; and
a module to display a clipped coupon image when the clippable coupon is clipped.

60. The medium of claim 59, further comprising a module to store an entry in a security log upon determining user identity invalidity

61. The method of claim 59, further comprising a module to store an entry in a security log upon determining coupon invalidity

62. A memory for access by a program module to be executed on a processor, comprising:
a data structure stored in the memory, the data structure comprising
a clippable coupon name field type,
a coupon server name field type,
a path field type, and
a script field type.

63. The memory of claim 62, wherein the data structure stored in the memory is referenced by a user identifier.

64. The memory of claim 63, wherein the identifier is placed in off-line media.

65. The memory of claim 62, further comprising a width field type.

66. The memory of claim 62, further comprising a height field type.

67. The memory of claim 62, further comprising an effective date field type.

68. The memory of claim 62, further comprising an expiration date field type.

69. The memory of claim 62, further comprising a coupon number field type.

70. The memory of claim 62, further comprising a coupon value field type.

71. The memory of claim 62, further comprising a limited series field type.

72. The memory of claim 62, further comprising a redemption history field type.

73. The memory of claim 62, further comprising a parameters field type.

74. The memory of claim 73, wherein the field type is a paired text list of parameters and values.

75. The memory of claim 62, wherein the data structure is embodied in Hyper Text Markup Language.

76. The memory of claim 62, wherein the data structure is embodied in Web Markup Language.

77. A memory for access by a program module to be executed on a processor, comprising:
an interaction interface invocable by the program module in response to a request to display unused clipped coupons, the interaction interface including a folio having a viewable list constructed for displaying unused clipped coupons.

78. The memory of claim 77, wherein the folio further comprises an organizing structure for the unused clipped coupons.

79. The memory of claim 78, wherein the organizing structure for the unused clipped coupons is hierarchical.

80. The memory of claim 79, further comprising:
at least one inbox acting as an initial repository for a new unused clipped coupon.

81. The memory of claim 79, further comprising:
a user added coupon folder.

82. The memory of claim 79, wherein the hierarchical organizing structure for the unused clipped coupons further comprises an option to re-organize the folio hierarchy.

83. The memory of claim 77, wherein the clipped coupons are represented by a set of images.

84. The memory of claim 77, wherein the folio resembles a coupon organizer.

85. A system, comprising:
means to display a clippable coupon;
means to detect a coupon clip;
means to obtain a user identifier;
means to obtain a clippable coupon identifier;
means to receive a message including the clippable coupon identifier and the user identifier;
means to determine clippable coupon validity;
means establish user identitfier validity;
means to identify an account based upon the user identifier;
means to instantiate the clippable coupon in the user's account; and
means to identify the clippable coupon as clipped.

86. The system of claim 85, wherein means to determine coupon invalidity further, comprises means to display an error message upon establishment of coupon invalidity.

87. The system of claim 85, wherein means to establish coupon invalidity further, comprises means to log an error message in a security log upon establishment of coupon invalidity.

88. The system of claim 85, further comprising:
means to store the user identifier in a cookie file on the client device.

89. The system of claim 85, further comprising:
means to obtain the user identifier from a cookie file on the client device.
